(19) United States
(12) Patent Application Publication
(10) Pub. No.: US 2011/0079685 A1
(43) Pub. Date: Apr. 7, 2011

(54) Adjustable, Telescoping and Rotating Television Mount

(76) Inventor: Jonathan J. Kwak, Winter Garden, FL (US)

(21) Appl. No.: 12/573,137

(22) Filed: Oct. 4, 2009

(51) Int. Cl. A47B 96/07; F16L 3/08

(52) U.S. Cl. 248/65; 248/274.1; 248/291.1; 248/205.1

(57) ABSTRACT

An adjustable, telescoping and rotating television mount for mounting a flat panel display screen on any secure, flat horizontal surface of furniture or on a built-in wall entertainment center. The front of the television mount comprises of an adjustable VESA (Video Electronics Standards Association) MIS-E, and MIS-F compliant television bracket, which attaches to the mounting holes on the rear of the VESA compliant display set. This television and bracket assembly is secured to the rest of the mount via a rotating joint and the sliding upper mechanism of the mount. The sliding upper mount assembly attaches to the height-adjustable base mount assembly of the mount, which is bolted onto a flat surface to secure the television. The mounted display telescopes in and out and also rotates/spins in a ninety-degree quadrant to set in a horizontal or vertical position of the mounted display.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

1. Field of the Invention

The present invention relates to a display mount and, in particular, an adjustable telescoping and rotating television mount for supporting a flat panel display screen mounted onto a flat horizontal baseboard of furniture.

2. Description of the Prior Art

Many people are unable or unwilling to upgrade their existing smaller CRT television to a newer and larger wide-screen LCD/LED/Plasma display due to the size and shape of their existing entertainment center furniture or built-in wall entertainment center. Most older television furniture and entertainment centers fabricated before the new millennium were built for a square, smaller screen CRT television set, and thus, physically, cannot accommodate the newer and larger wide-screen flat panel displays sold currently. Many owners, who bought the expensive furniture as a matching set or to flow with the overall décor of an interior home design, are unwilling to discard such furniture simply to upgrade the television set to a larger and better unit. Thus they must bear with the older, inferior standard television viewing even though they really want to upgrade the display to the better quality HDTV.

Different adjustable television mounts have heretofore been known. However, none of the adjustable television mounts adequately satisfy these aforementioned needs.

U.S. Pat. No. D517,085 (Deuschle) discloses a universal television bracket designed to mount any flat panel display onto the wall. While the H shaped bracket is similar in design to this current invention, the mount is simply a wall mount. Most mounts sold on the market currently can only be used to attach a television set on the wall and not on furniture. Furthermore, as in most bracket designs of a television mount, in order to make them universal, the bracket assembly consists of sliding, movable parts that fasten onto the back of the television set. Any adjustable sliding parts on the television bracket would not be suitable for a mount that is specifically designed to rotate and be set in either horizontal or vertical position. The frequent movement of the television set may loosen such part and slide the television while in a vertical position, causing severe damage.

U.S. Pat. No. 5,720,230 (Mansfield) discloses a sliding, pull out shelf that can be used to hold a television set and slide it in and out of the attached furniture. While the telescoping nature of the shelf is similar in design to the current invention, the slide mechanism is near the baseboard in which it is attached to, and thus if the furniture has a doorframe or any ornamental design on the front part of the television compartment's baseboard, then the shelf cannot be pulled out. Furthermore, if such a heavy-duty, pull-out shelf were to be used for setting a large, wide-screen display set in front of the small television compartment, it will not be able to be slid back into the compartment; and in addition, if the furniture had hutches with doors on the sides, then the hutch doors will not be able to be opened since the television is sitting in its way of opening them. Lastly, if a large television gets set on top of the pulled-out shelf in front of the furniture without properly securing the furniture to a wall, then the television and the furniture may tip over and cause damage and harm. In addition, if the shelf was pushed in accidentally while the television set was on top of it, the television will fall to the ground and cause damage as well.

U.S. Pat. No. 7,028,961 (Dittmer et al.) discloses an adjustable mount that can rotate/pivot and move the attached television in and out of the mounted position. While the rotating feature of the adjustable mount is similar in design to the current invention, this adjustable mount is designed to be mounted on a wall or on a fixed vertical plane only, thus not suitable to be used on attaching to furniture. Also, since the mount moves the attached display in and out in a single horizontal plane, the mount is not height adjustable. Lastly, the rotating/pivoting joint of the adjustable mount is a friction joint, and as such, it cannot accommodate a heavy, large screen display for rotating purposes.

U.S. Pat. No. D568,325 (Muday et al.) discloses the design for a cantilevered desktop mount. While this desktop mount's general framework of attaching the display to the baseboard of the furniture is similar in design to the current invention, the desktop mount can only be attached to the edge of furniture only. In addition, the desktop mount lacks the function of telescoping the attached display in and out of the mounted furniture. Lastly, the mount bracket and the general weak design of the mount are not designed to hold a large screen display.

U.S. Pat. No. 7,243,892 (Pfister) discloses an adjustable mount that can be made to attach to a vertical base stand to function as a desktop mount. While the adjustable mount's moving arm can be pulled in and out to move a mounted television set similar to the current invention, it lacks linear telescoping function of the movement and thus may result in the display hitting the furniture during the movement. Furthermore, the mount can tilt/swivel the attached display but it lacks the rotating function of the mounted television, which allows for the opening of side hutch doors. Lastly, the mount bracket and the general weak design of the mount arms are not designed to hold a large screen display.

This new television mount invention is designed to mount a large wide-screen display onto any existing furniture with a secure flat surface to solve this problem. The unique telescoping and rotating mechanism, along with the durable design of the television mount, allows for the mounting of a large wide-screen television set on a smaller square framed television compartment, as well as on a cabinet/armoire entertainment center with closing doors. For the foregoing reasons, there is a need for a new adjustable television mount capable of telescoping and rotating the attached flat panel display.

### BRIEF SUMMARY OF THE INVENTION

Despite the recent HDTV conversion and subsequent lowering of large screen HDTV prices, I have noticed that many homes still have small CRT television sets in the main family rooms. Many are simply unwilling to part with their old furniture regardless of the advantage of upgrading to a larger and better quality HDTV. Also, numerous large cabinet/armoire style furniture with matching hutches were built with the wrong aspect ratio in the television compartment. The television compartment is shaped longer vertically than horizontally, thus not allowing a wide-screen television placement inside the unit. Moreover, armoire/cabinets built with closing doors have a doorframe that is located over the bottom of the television opening that prevents any currently available television sliding tables sold on the market to place a television out of the cabinet and suspend outside the smaller frame.

The current invention consists of a television mount bracket that attaches to the back of any VESA (Video Electronics Standards Association) compliant television with screen diameter larger than 58.42 cm or 23 inches wide. The adjustable mounting bracket attaches to the unique telescoping/sliding upper mount assembly via a rotating joint that rotates/spins the display 360 degrees. Since the display connects to components through cables, the free-spinning mechanism must be limited by two rotation guidance brackets attached on the slide body to limit the motion within a 90-degree quadrant to prevent cables from getting tangled and causing damage. The two rotation guidance brackets are equipped with double roller catches on each end to catch the television on either vertical or horizontal set position.

The slide mechanism on the upper mount assembly telescopes the display out of the smaller framed furniture to make it possible to mount a much larger display on a small-framed furniture. It also allows the wide-screen display to be rotated to a vertical position and pushed entirely inside the rectangular cabinet/armoire with closing doors to be stored and closed off from view. When mounted on a small, square-framed television compartment of a furniture, the telescoping feature of the mount keeps the television out permanently in a horizontal viewing position, however; if such furniture has hutches attached next to it where a door must be opened, then the television can be rotated/spun out of the way so the doors to the hutches could be opened. In addition, the telescoping mechanism of the mount allows for easy access to the cable attachment panel behind the television set as well.

The upper mount assembly is attached to the base mount assembly via two sets of nuts and bolt and can be height adjusted to allow universal fitting of a television 58.42 cm or 23 inches and larger. This height adjustment function of the current invention allows for it to be used as an alternate television stand that can be utilized to either raise or lower the height/position of the television on any furniture. The base mount assembly is attached to the furniture on a fixed stable horizontal baseboard via four sets of nuts and bolts. This mount is designed to keep a heavy television set flushed out in front of the furniture, which can lead to the shifting of overall weight balance of the structure as a whole. Thus, the mount must be attached to the nearby wall to prevent tipping of the furniture.

This mount can also be used on corner entertainment units. To mount a much larger television on a fixed corner space without the current invention, the corner furniture would have to be pulled out awkwardly away from the corner of the room to accomplish this task. However, using the unique upper slide out mechanism of the current new invention, the television can be pulled out away from the limiting corner walls without moving the corner furniture away from the corner of the room. The pulled-out slide, holding the television away from the adjoining walls, enables the mounting of a much larger wide-screen display on the said furniture without unnaturally pulling out the furniture away from the corner.

Finally, this mount can also be used for graphic intensive computer programming that requires using large horizontal or vertical displays as computer monitors on a desktop surface. Also, the current invention can be used to mount a flat panel display vertically or horizontally as a commercial display board. Such display can be used as counter-top style mounting for vertical signs or announcement boards in a commercial/presentation setting by simply removing the rotating functionality from the mount during the assembly of the mount.

### BRIEF DESCRIPTION OF THE SEVERAL VIEWS OF THE DRAWING

For a more complete understanding of the present invention and complete working mechanics thereof, the accompanying drawings are which:

FIG. 1 is a perspective drawing of the television mount in completely assembled form.

FIG. 2 is an unassembled drawing of the 3-piece VESA mount bracket for the front part of the complete mount.

FIG. 3 is the assembled VESA mount bracket for the front part of the complete mount.

FIG. 4 is the functional diagram drawing of the possible VESA mounting positions for the installation of VESA compliant flat screen display to the mount.

FIG. 5 is a perspective drawing of the rotational box insert, necessary for the rotating mechanism of the front VESA mount bracket.

FIG. 6 is a perspective drawing of the slide body, the rotation guidance brackets, and the double roller catches that are unassembled.

FIG. 7 is a drawing comprising of complete slide body assembly with the installation of drawer slides to the two sides.

FIG. 8 is a side view of the VESA mount bracket, rotational box insert, and the complete slide body assembly with drawer slides. Hardware for putting three parts together is also shown in perspective to the position of assembly.

FIG. 9 is the assembled side view of FIG. 8. Dashed lines show the inner assembled view of the rotational box insert inside the slide body.

FIG. 10 is a perspective drawing of the upper mount assembly.

FIG. 11 is the rear view of the upper mount assembly.

FIG. 12 is the right-side view of the upper mount assembly.

FIG. 13 is the top view of the upper mount assembly.

FIG. 14 is a blown-up drawing of the upper portion of FIG. 11. The drawing displays the drawer slide attachment to the inside of upper mount channel.

FIG. 15 is the right-side perspective view of the base mount.

FIG. 16 is the left-side perspective view of the base mount and unattached drawing of the rear channel cable management bracket.

FIG. 17 is the front view of the assembled, complete mount with the flat panel display attached. The display is shown using dashed lines.

FIG. 18 is the rear view of the assembled, complete mount with the flat panel display attached.

FIG. 19 is the right side view of the assembled complete mount with the flat panel display attached and the slide body assembly pulled half way out.

FIG. 20 is the left-side view of the assembled complete mount with the flat panel display attached and the slide body assembly pulled half way out.

FIG. 21 is the top view of the assembled complete mount with the flat panel display attached and the slide body assembly pulled half way out.

FIG. 22 is the right-side view of the assembled complete mount with the flat panel display attached. The drawing shows the actual mounting schematics and hardware parts used to mount the television and mount to the furniture/baseboard and to the nearby wall.

FIG. 23 is the perspective view of the complete assembled mount without the flat panel display located inside the opening of the furniture. The drawing also shows the reinforcement angle brackets for the baseboard attachment to the side panels and installation of the television mount to the baseboard and to the nearby wall.

FIG. 24 is the first movement drawing of the mount and the attached television in a vertical position, before television telescopes out.

FIG. 25 is the second movement drawing of FIG. 24, where the television is telescoped out.

FIG. 26 is the front view of the third movement drawing of FIG. 24, where television is telescoped out and is being rotated to the halfway point.

FIG. 27 is the fourth movement drawing of FIG. 24, where the television is telescoped out and rotated to a set horizontal position.

FIG. 28 is a drawing of the square opening entertainment center furniture with side hutches but with no television.

FIG. 29 is a drawing of the furniture in FIG. 28 with an old, small CRT box television set in the television compartment.

FIG. 30 is a drawing of the furniture in FIG. 28 with large, wide-screen flat panel television mounted inside the square opening of the entertainment center using the current invention. The television is positioned in a vertical position, which allows the side hutch doors to open.

FIG. 31 is a drawing of the furniture in FIG. 28 with a large, wide-screen flat panel television mounted inside the square opening of the entertainment center using the current invention. The television is positioned in a horizontal position for television viewing.

FIG. 32 is a drawing of an armoire furniture entertainment center with doors closed.

FIG. 33 is a drawing of the furniture in FIG. 32 with the doors open and a wide-screen television mounted inside the furniture in a vertical position for storage.

FIG. 34 is a drawing of the furniture in FIG. 32 with the doors open and the television telescoped out and in the halfway point of rotation.

FIG. 35 is a drawing of the furniture in FIG. 32 with the doors open and the wide-screen television completely telescoped out and rotated in a horizontal position for viewing.

### DETAILED DESCRIPTION OF THE INVENTION

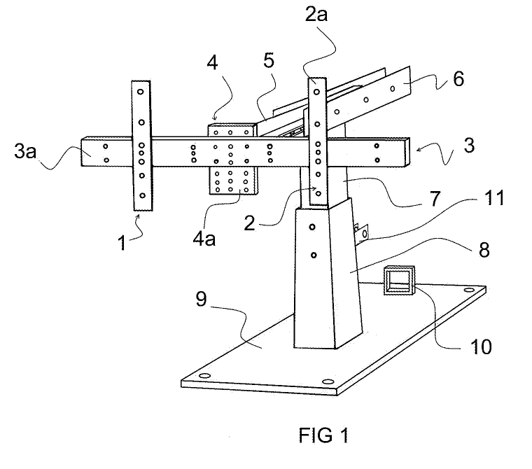

The adjustable mount shown in the Figures is principally intended for mounting a large LCD/LED/Plasma wide-screen television set to any fixed horizontal baseboard. The adjustable mount shown on FIG. 1 is formed by five major components as follows: the VESA (Video Electronics Standards Association) compliant television bracket in the front of the mount, the rotational box insert, the slide body assembly attached behind the VESA compliant television bracket via the rotational box insert, the upper mount assembly which is connected to the slide body assembly via a set of heavy-duty drawer slides, and lastly, the base mount assembly which is attached to the horizontal baseboard of furniture. The complete mount must be manufactured using either aluminum or steel for structural integrity in permanently holding a heavy television set in a fixed support.

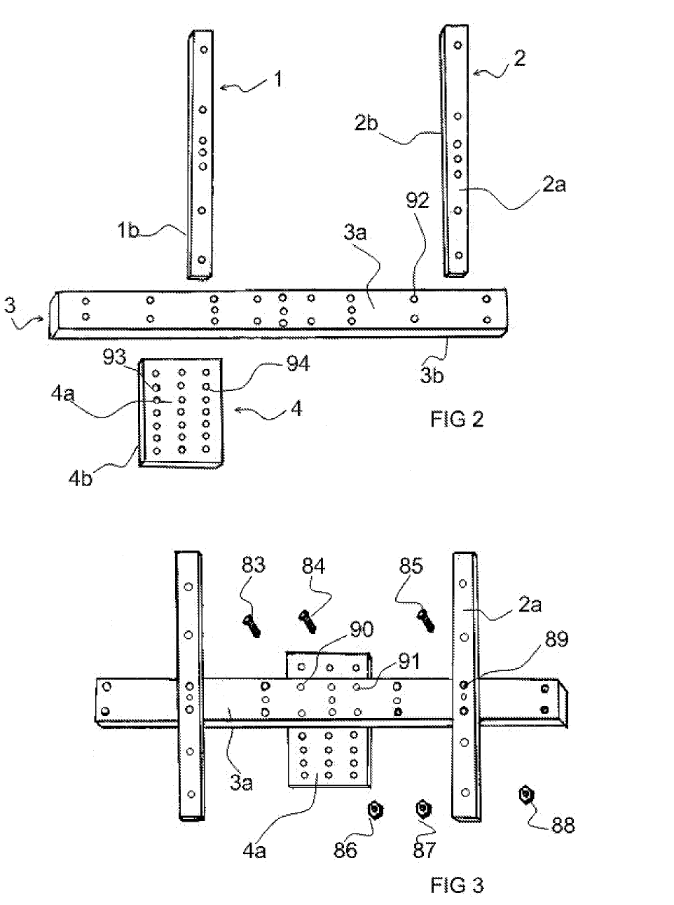

The VESA compliant television bracket assembly comprises of two adjusting television attachment plates 1 and 2, which are attached to a bracket cross bar 3 via four sets of nuts and bolts. As shown in FIG. 2, the rear sides of plates 1b and 2b are perpendicularly lined up to the front surface of cross bar 3a. The positioning of part 1 and 2 respective to 3 is determined by the VESA compliant drill pattern of the television to be mounted. The wider the VESA compliant drill pattern of the television to be mounted, the wider the placement of part 1 and 2 will be to attach the television to the appropriate outer holes on plates 1 and 2. The middle two holes on the plates 1 and 2 are the attachment points to the cross bar 3 as shown in FIG. 3. A 1.90 cm or three-quarter inch long bolt 85 goes through side 2a, then through hole 89 on part 2, to hole 92 on part 3 through to the rear side 3b and tightened by nut 88, holding the two pieces 2 and 3 together. An additional identical nut and bolt configuration follows beneath the previous assembly on the lower middle hole of plate 2 to prevent plates 2 and 3 from any rotational movement. Part 1 and 3 is attached in identical configuration as attachment of part 2 and 3 on the corresponding opposite side of part 3 with two additional sets of identical nuts and bolts.

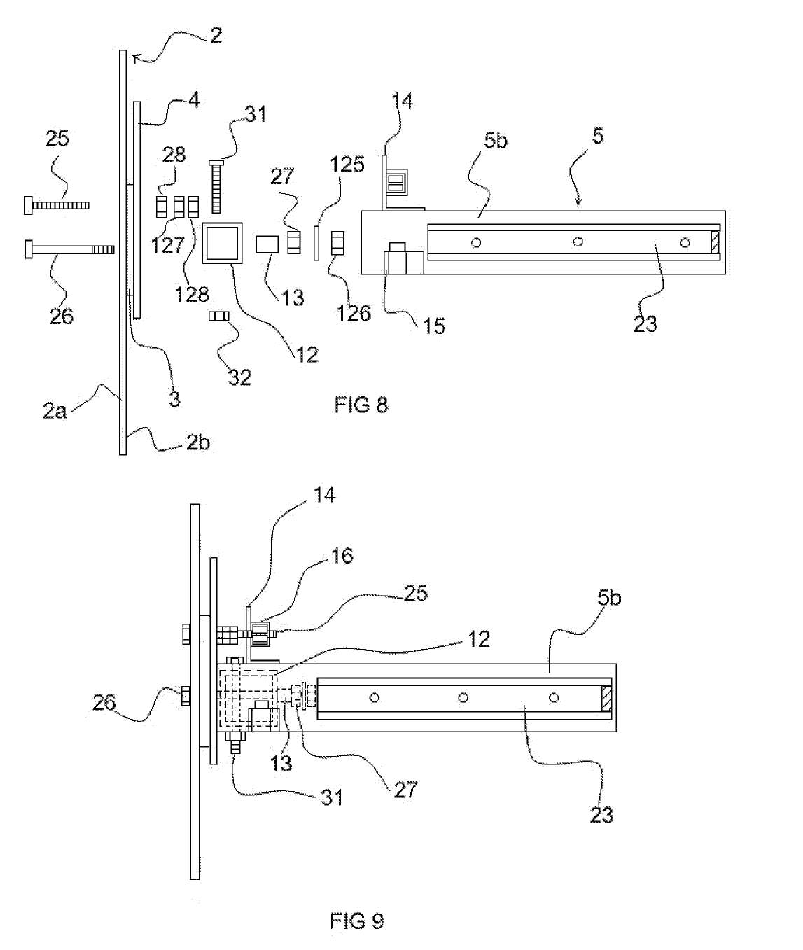

The third piece of the VESA standard television bracket is the television centering plate 4, which is a square metal plate with twenty-one holes drilled in three by seven pattern, spaced out 2.54 cm or one inch apart from each other in all four directions. The outer two lines of the seven vertical holes are used to attach part 3 and 4 together, while the middle line is where the rotation stopping bolt 25 and the long bolt for the rotational box insert 26 of FIG. 8 attaches the VESA compliant television mounting bracket to the rotational box insert, which then attaches the whole front structure to the slide body assembly. A 1.90 cm or three-quarter inch long bolt 83 goes through the hole 90 on side 3a of part 3 then pass through hole 93 of part 4, and the nut 86 would tighten together to hold parts 3 and 4 together, joining sides 3b and 4a together. Bolt 84 in the same configuration will go through hole 91, then through hole 94, then tighten with nut 87 in the same manner as bolt 83 and nut 86. Two more holes on the opposite outer lower edge of cross bar 3 will take two more sets of identical nuts and bolts (not shown in drawing) to have a square-shaped nuts and bolts pattern to attach part 3 and 4 together firmly and prevent any shifting of the attached parts.

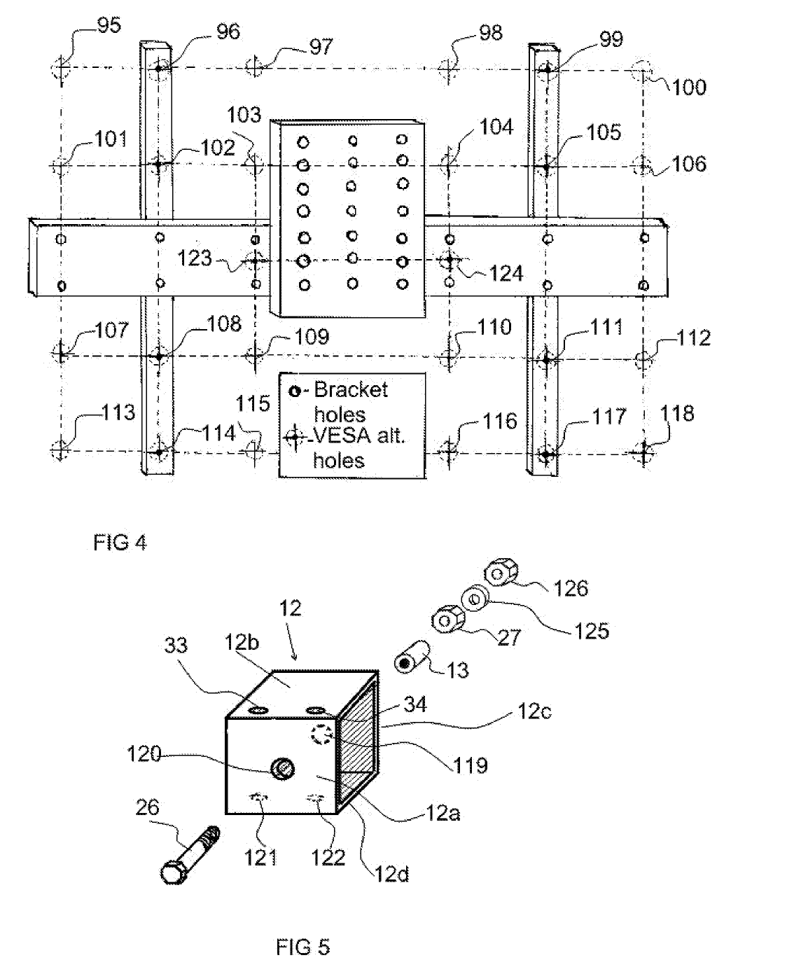

FIG. 4 is a drawing of the VESA compliant television bracket from the rear, showing all possible mounting points of VESA compliant television sets. The legend annotates solid circles as being holes for bracket mounting and circles with cross hair as being possible points of television mounting. The length between positions 100 and 118 is 400 mm, and the length between positions 95 and 100 is 600 mm, and lastly the length between positions 104 and 124 is 100 mm. VESA compliant mounting hole patterns are designated as MIS-B, C, D, E, and F. MIS-B, C, and D holes are for displays smaller then 58.17 cm or 22.9 inches in diameter and thus are not compatible with this invention. MIS-E hole pattern is for displays sized in diameter from 58.42 cm or 23 inches to 78.49 cm or 30.9 inches. MIS-E drill pattern is 100×200 mm, which corresponds on FIG. 4 to set of holes 103,104,123, and 124, or to set of holes 123, 124, 109, and 110. The adjusting television attachment plates 1 and 2 must be positioned in front of corresponding holes 97, 103, 123, 109, 115 and in front of corresponding holes 98, 104, 124, 110, 116 and attached to part 3 via corresponding bracket holes for VESA MIS-E television mounting.

MIS-F hole patterns are for displays sized 78.74 cm or 31 inches in diameter and above, and the drill patterns are spaced apart from each other in 200 mm increments, such as 200×200 mm, 400×200 mm, 400×400 mm, 600×200 mm, and 600×400 mm. In FIG. 4, MIS-F 200×200 mm pattern can be mounted on set of positions: 97, 98, 123, 124, or 103, 104, 109, 110, or 123, 124, 115, 116, with parts 1 and 2 attached to part 3 in the corresponding innermost bracket holes. The MIS-F 400×200 mm pattern can be mounted on set position 102, 105, 108, and 111, with parts 1 and 2 attached to part 3 in the corresponding middle bracket holes. The MIS-F 400×400 mm pattern can be mounted on set position 96, 99, 114, and 117, with parts 1 and 2 attached to part 3 in the corresponding middle bracket holes. The MIS-F 600×200 mm pattern can be mounted on set position 101, 106, 107, and 112, with parts 1 and 2 attached to part 3 in the corresponding outermost bracket holes. The MIS-F 600×400 mm pattern can be mounted on set position 95, 100, 113, and 118, with parts 1 and 2 attached to part 3 in the corresponding outermost bracket holes.

After assembling parts 1, 2, and 3 together in accordance to the corresponding television's VESA drill pattern, the television centering plate's mounting position can be determined. Since the VESA compliant drill pattern mounting holes behind the television set is always centered in respect to the width of the television, width centering adjustment is not necessary; however, most drilled hole patterns are off-centered in length, thus the television centering plate becomes a necessity for centering the television in respect to the center point of attachment to the mount. The actual television set's center point must be measured and marked as a reference point in figuring out the exact position of attachment of part 4 to the VESA compliant television bracket. Once the center of the television is marked, the assembled parts 1, 2, and 3 need to be loosely attached to the television set using four M6 or M8, 1.90 cm or three-quarter inch long machine screws. Then the television centering plate can be held up to the attached VESA compliant television bracket, and the position of attachment of the television centering plate to the horizontal cross bar plate of the television bracket can be determined. The hole closest to the actual center of the television must be marked off for connecting the rotational box insert later. The television now can be separated from the bracket and parts 3 and 4 can be attached together using four sets of 1.90 cm or three-quarter inch long bolts and nuts. Lastly, when determining the attachment position for parts 3 and 4, the location of rear cable connection panel on the television must be taken into consideration during the process as well. Part 4 should be positioned as to not cover the rear cable connection panel since this would make cable connection impossible. The multi-adjustable positioning of parts 3 and 4 is a useful and necessary feature of the invention, as all televisions on the market come in varying configuration of locations of VESA compliant hole drill patterns and positions of the rear cable connection panel.

FIG. 5 is a perspective assembly drawing of the rotational box insert 12 and the hardware for attachment to the VESA compliant television bracket assembly. The rotational box insert is a square tube that has equal length on all sides. As shown in FIG. 5, side 12a faces the front of the mount. The partially threaded long bolt 26, will go through 3a or 4a through the pre-determined center hole of part 4, then pass through hole 120, then through hole 119, then through the spacer 13, then tightened by nut 27, then a washer 125, then lastly, tightened by an additional nut 126. The second nut and washer act as the safety mechanism, which will hold the first nut 27 in place during the regular rotating operation of the mount. Most available long bolts on the market are only partially threaded on the opposite attachment end, thus spacer 13 is manufactured precisely to fit between the beginning line of the threading on the long bolt and the rear side of the rotational box insert 12c. Since the bolt can either go through both parts 3 and 4 or only through part 4, depending on the center hole location in respect to the television, two different length spacers must be available for use for assembly. After the bolt 26, VESA compliant television bracket, rotational box insert 12, the spacer 13, nut 27, washer 125 and nut 126 is tightened together, the gap between side 4b and 12a should be minimal (less than 1 mm), and just enough to allow for free rotation of the rotational box insert 12 against side 3a. This gap should also not be large enough to allow any loose space between the VESA compliant television bracket and the rotational box insert 12, which may result in unwanted television tilting after the complete installation. During this assembly point, if the fully assembled mount is to be set for a fixed position mounting, then an additional washer (not shown in drawings) can be inserted around the bolt between 12c and 13, which will remove the slight gap between the rotational box insert and the VESA compliant television mount, and thus removing the rotating functionality of the current invention. If used for commercial display or if the rotational movement of the television is simply not desirable in the ultimate use for the flat panel display, then the rotational functionality of the mount can be simply removed from the invention using an additional washer during the assembly.

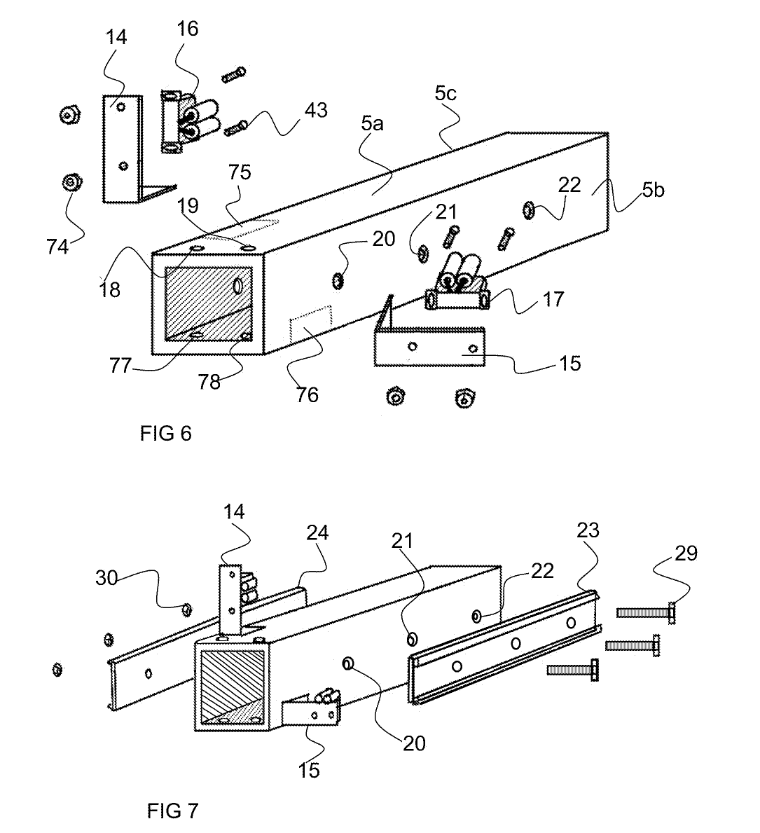

FIG. 6 is an assembly drawing of the slide body 5 and the rotation guidance system brackets 14 and 15. While the mount can rotate the television three hundred and sixty degrees in motion; the television set is attached to cables which is then attached to something else, thus this full rotation can lead to cord entanglement and attached peripheral equipment damage. Therefore, a mechanism to limit the rotation to a single quadrant of ninety degrees is necessary. The rotation guidance brackets 14 and 15 must be welded onto positions 75 and 76 of the slide body 5, depicted by the dotted lines in FIG. 6 during the manufacturing of the mount. Then any two standard double roller catches 16 and 17, which are mainly used to hold furniture doors, get attached to parts 14 and 15 via a small machined bolt 43 and a nut 74. Another set of identical nut and bolt (not shown in drawings) must be used in an identical fashion on the opposite attachment point of parts 14 and 15 with the double roller catches 16 and 17 to secure the two pieces in place on the rear side of the rotation guidance brackets. Once assembled together, the rotation stopping bolt 25 of FIG. 8 will be caught by the double roller catch on part 14 to set the television in the horizontal viewing position or caught by the double roller catch 15 to set the television in the vertical storage position.

FIG. 7 shows the drawer slide's removable outer extension pieces being attached to the fully assembled slide body 5 on its left and right sides. The right drawer slide extension 23 attaches to side 5b via three bolts. The long bolt 29 travels through the hole on right drawer slide extension 23 then through hole 22 of side 5b, then through the corresponding opposite hole on side 5c, then through the hole on the left drawer slide extension 24, then tightens onto nut 30 to secure both drawer slide extensions to the slide body assembly. Two other identical nuts and bolts fasten in the other two identical configurations through holes 21 and 20 to make this assembly complete. The drawer slide used on this invention must be a full-extension, heavy-duty drawer slide, rated at 90.90 kg or two hundred pounds or above in order to hold a flat panel display weighing up to 31.82 kg or seventy pounds. An alternate assembly model for attaching the drawer slides would be to weld them onto the slide body assembly during the manufacturing process.

Once the VESA compliant television bracket and slide body assembly have been assembled separately, the two main components are then attached together by the rotational box insert 12, which is attached to the VESA compliant television bracket, then inserted inside the square opening in front of the slide body assembly. As shown in FIGS. 8 and 9, the rotation stopping bolt 25 must be inserted in the television centering plate 4 exactly two holes up from the long bolt 26 attachment point, to line up exactly to be caught by the double roller catches on part 14 and 15. After the rotation stopping bolt is tightened on to the television centering plate using a nut 28, two more identical nuts 127 and 128 should be fastened behind the first nut to prevent the rotation stopping bolt from bending while being used to stop the rotating television. Lastly, after the rotational box insert is inserted inside the slide body assembly, two long bolts 31 (and one long bolt not shown in drawing) will travel through holes 18 and 19 on part 5, side 5a, then through holes 33 and 34 of part 12 on side 12b, then through holes 121 and 122 of part 12, then through holes 77 and 78 out of part 5 and be fastened by nut 32 (and another identical nut not shown in drawing) to hold the two main components together.

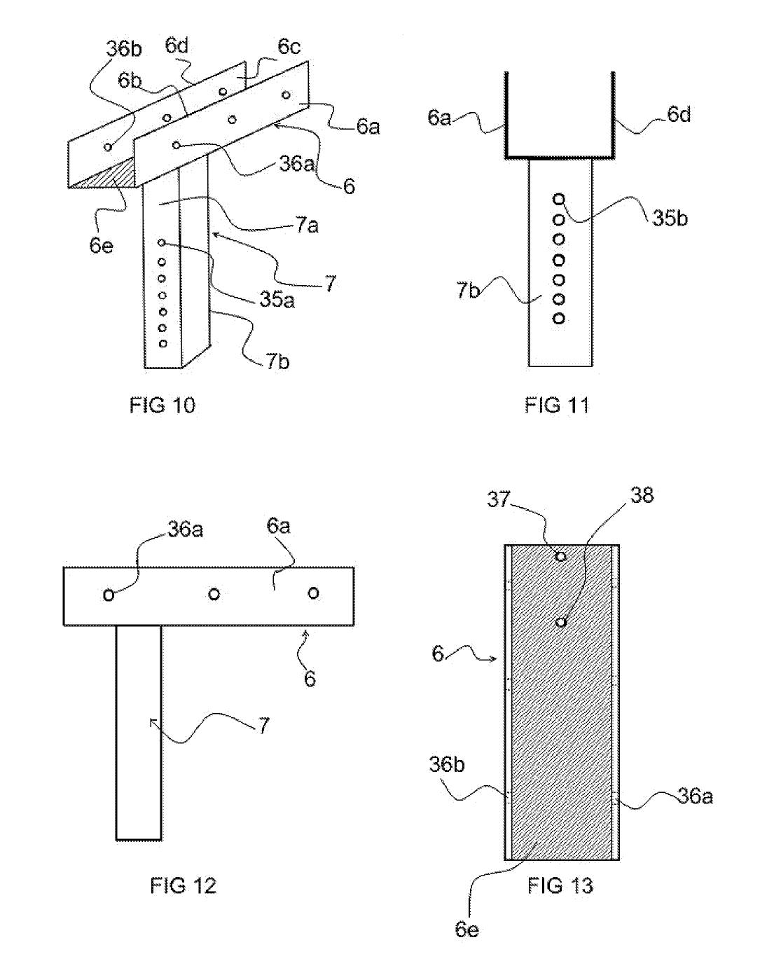

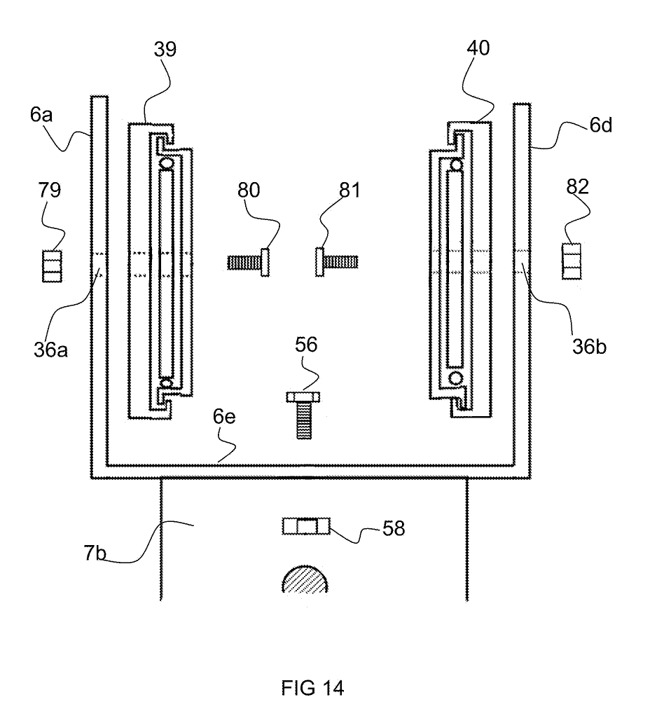

FIGS. 10, 11, 12, and 13, show different views of the same upper mount assembly. The upper mount assembly comprises of the upper channel with three holes on each side, and a square tube below, which is welded on the bottom of the channel during the manufacturing. The square tube should be welded closer to the front side of the channel to shorten the lever arm length and thereby reducing the overall torque generated by the mounted television set on this welded joint. The square tube portion has plurality of holes drilled along the opposite two sides of front 7a and back 7b, 2.54 cm or one inch apart, for height adjustment of the mount. Before attaching the previously assembled three major components to the upper mount assembly, the main body of the drawer slides must be attached to the upper mount assembly as shown on FIG. 14. The full-extension, heavy-duty drawer slides used here can be of any brand or manufacture, but must be rated at least 90.90 kg or two hundred pounds or higher as stated previously.

As shown on FIG. 14, the main body of drawer slides 39 and 40 attach to inner sides of the channel part 6 on sides 6b and 6c. A short, pan-headed machine screw 80 will travel through the hole on the right slide body 39, then through side 6b through hole 36a, then out through side 6a and be fastened by nut 79. Two more sets of identical nuts and bolts (not shown in the drawing) fasten on the same side through the two remaining holes to attach part 39 to part 6. Another pan-headed machine screw 81 will travel through the hole on left slide body 40, then through side 6c through hole 36b, then out through side 6d and be fastened by the nut 82. Two more sets of identical nuts and bolts (not shown in the drawing) fasten on the same side through the two remaining holes to attach part 40 to part 6. An alternate assembly model for attaching the drawer slides would be to weld them onto the inner sides of the channel during the manufacturing process

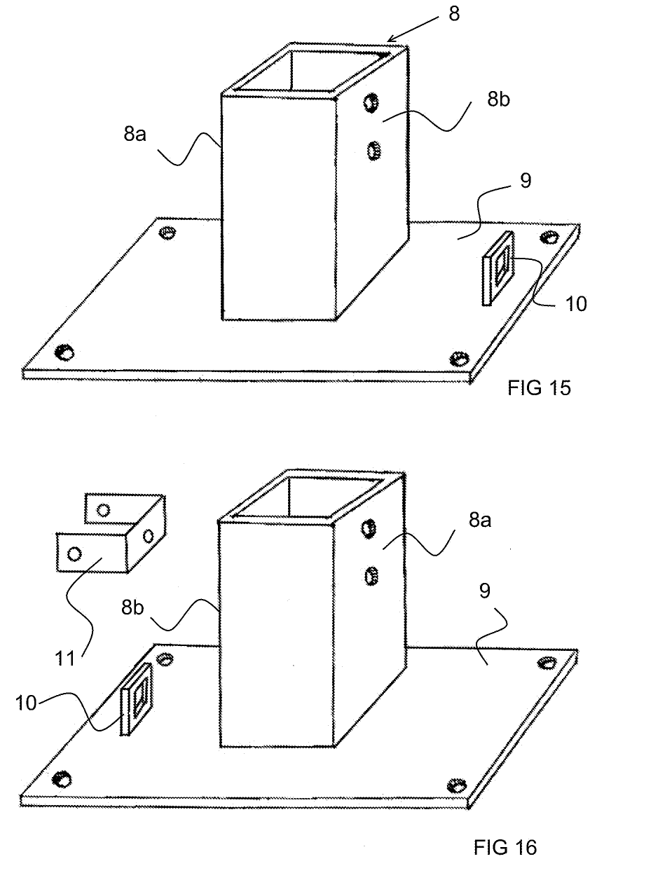

FIGS. 15 and 16 show opposite side perspective views of the base mount assembly. The base mount assembly consists of a square tube 8, with two holes drilled 5.08 cm or two inches apart on opposite sides 8a and 8b on the upper portion of the tube, and the base mount plate 9. The square tube is welded on the center of the base mount plate during the manufacturing to make as one piece. The square tube opening is large enough to fit the lower square tube portion of the upper mount assembly to connect the two pieces together. The base mount plate has four holes near the four edges and the four holes serve as final mounting points for the television mount and the furniture baseboard.

The base plate also has a thin square-shaped tube attached behind side 8b and in between the two rear holes by welding during the manufacturing process. This square piece 10 is the lower part of the cable management system, while the upper part of the cable management system is the channel shaped bracket part 11, which has three holes as shown in FIG. 16. The upper part of the cable management system 11 attaches to the side 8b by a nut and bolt through the holes on part 8 during the attaching of upper mount assembly's square tube 7 to the base mount assembly. Once the television installation is complete and cables attached to the television, the cables can be tied together with a cable tie, then pass through the channel of part 11, where an additional cable tie ropes the side two holes of the channel bracket together forming a square-shaped opening for the cables to pass through. The cables can then be fed through the opening of the lower square tube portion of the cable management system and pass on down to the peripheral attachments. This cable management system allows the cables to be managed in a neat manner and keeps the unsightly cables away from view by hiding the cables behind the square tube portion of the mount.

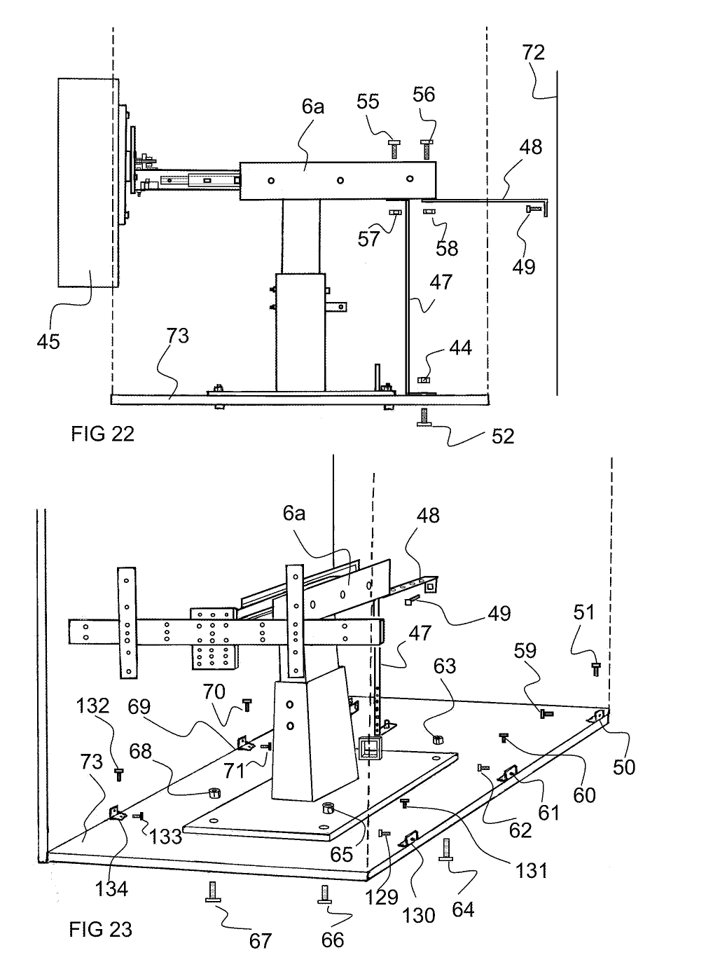

The base mount assembly can be mounted on the furniture by drilling four corresponding holes on the horizontal baseboard 73 where the mount should be fixed, as shown in FIG. 22 and FIG. 23. Then four bolts 67, 66, 64 and one bolt unable to be shown in FIG. 23 can be fastened through the four holes of the baseboard 73 and through the holes on the base mount plate, then fastened by four nuts 68, 65, 63, and one nut unable to be shown in FIG. 23. This firmly holds the entire mount and television to the furniture. The baseboards of some furniture are not securely fastened to the sides of the furniture, thus by using six angle brackets 50, 61, 130, 134, 69 and one bracket unable to be shown in FIG. 23, the baseboard 73 can be fastened to the side panels permanently and add additional support in holding the television and mount in place. Wood screws, 59, 62, 129, 133, and 71 (and one screw not shown in the drawing) will travel through the holes in the angle brackets to attach them to the side panels of the furniture, while wood screws 51, 60, 131, 132, and 70 (and one screw not shown in the drawing) will travel through the holes in the angle brackets to attach them to the baseboard 73 of the furniture, ultimately securing the baseboard 73 to the side panels.

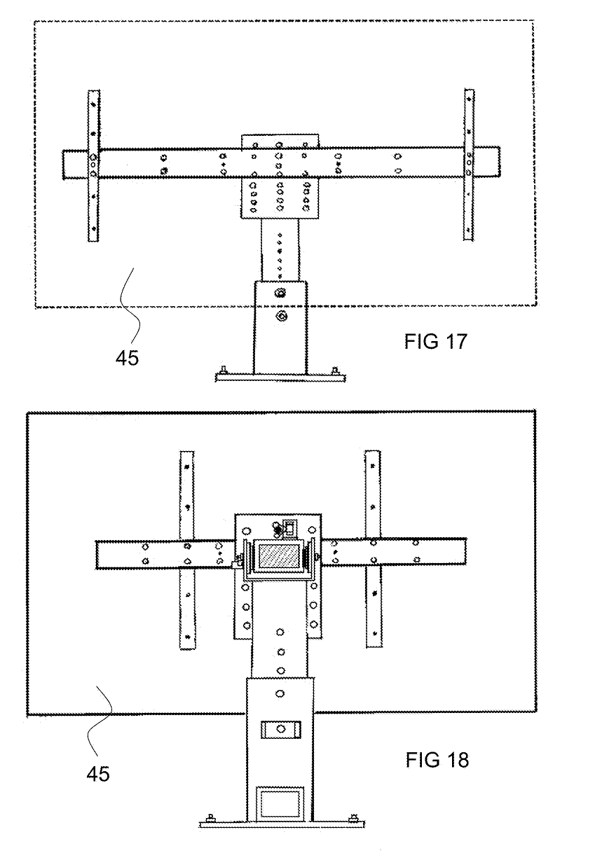

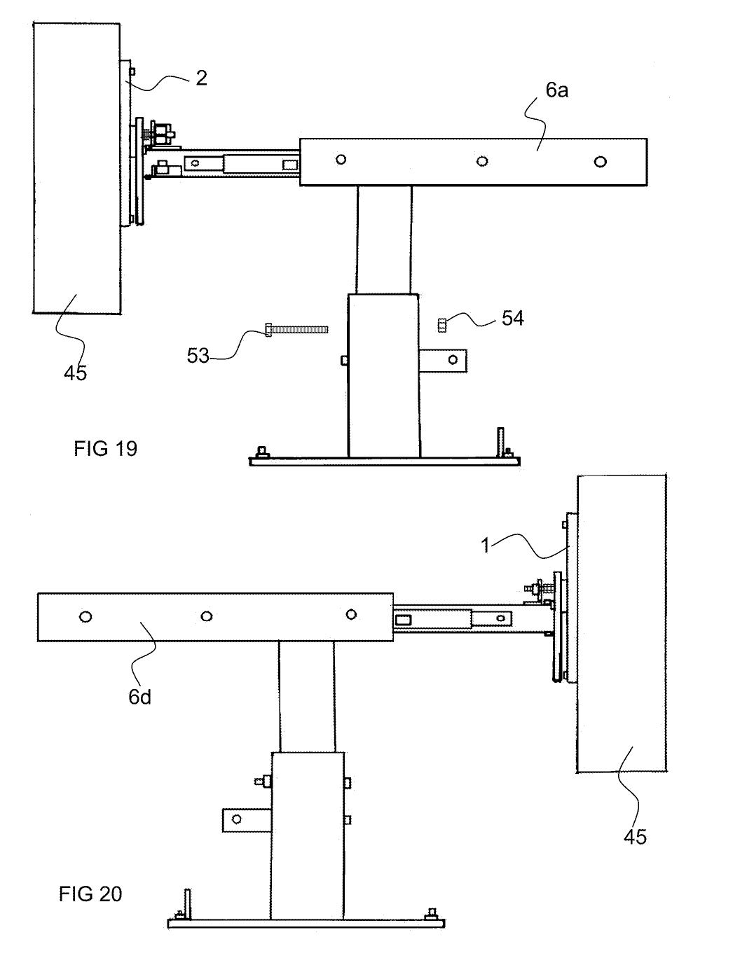

Once the base mount assembly is secured on the baseboard of the furniture, then as shown in FIGS. 17, 18, 19 and 20, the upper mount assembly's lower square tube can be slotted into the square opening of the base mount assembly. Depending on the width of television 45 being installed, the height adjustment must be made by measuring the television's width, then dividing by two. The distance between the bottom of the channel portion 6 of the upper mount assembly to the upper plane of the base mount plate 9 should be greater than the half length of the width of the television set 45 being mounted. The upper and base mount assembly can now be put together by making the distance from the bottom of the channel to the base mount plate several inches wider than the half length of the television, so that when the television is stored in a vertical position inside the furniture, as shown in FIG. 33, it fits inside the furniture and the mounted television is positioned higher than the base mount plate. As shown in FIG. 19, the long bolt 53 can be inserted through the hole of base mount assembly's square tube on side 8a, then through hole 35a of part 7, through 35b, then out through the hole on the base mount tube side 8b, then fastened by nut 54. Another identical set of nut and bolt tightens on the lower hole in the same configuration except when the bolt comes out through side 8b, the upper cable management system 11 is threaded through the bolt and then tightened by a nut to hold parts 8, 7 and 11 together, as shown in FIG. 20.

FIGS. 22 and 23 show the additional attachment of the complete mount to the furniture and to the nearby wall 72. As shown in FIGS. 22 and 23, an aluminum strip with holes punched along the middle 48 will be used to secure the upper mount assembly to the nearby wall 72. This attachment is absolutely necessary for the safety of the end user due to the fact that the mount will place the television outside of the furniture and will increase the likelihood of the whole structure in tipping forward, possibly resulting in injuries. Bolt 56 will pass through side 6e through hole 37 then through the corresponding hole of part 48, then fastened by nut 58. The other end of part 48 is to be attached to the wall 72 after being bent to fit within the distance between the attachment point of the upper mount assembly to the wall 72. When the strip is bent and fit in appropriate length, a hole must be drilled on the wall 72 where the corresponding end hole of part 48 will be attached to the wall 72. Finally, a sleeve-type hollow wall anchor (molly bolt) 49 can be used to attach the part 48 to the wall 72, and secure the mount and furniture to the wall 72 and prevent the furniture from tipping over.

The upper mount assembly must also be attached to the baseboard 73. To provide additional support, attaching another aluminum securing strip 47 with punched holes along the middle as shown in FIG. 22 to part 6 and the baseboard 73 is necessary. Once the upper mount assembly and the base mount assembly is put together and securely attached to the baseboard 73 and to the nearby wall, the two ends of part 47 can be bent and manipulated to fit between the bottom of channel part 6 and the baseboard 73 of the furniture. Bolt 55 can pass through side 6e through hole 38, then through the hole on part 47, then fastened by nut 57. The bent opposite end of the securing strip is placed on the baseboard of furniture 73 behind the base mount plate, then a hole can be drilled on the baseboard 73 to correspond to the holed end of the securing aluminum strip. Bolt 52 then travels through the hole drilled on the baseboard of the furniture 73, through the corresponding hole on part 47, then fastened by nut 44, thus securing the upper mount assembly to the furniture and adding counter weight support for the mounted television set.

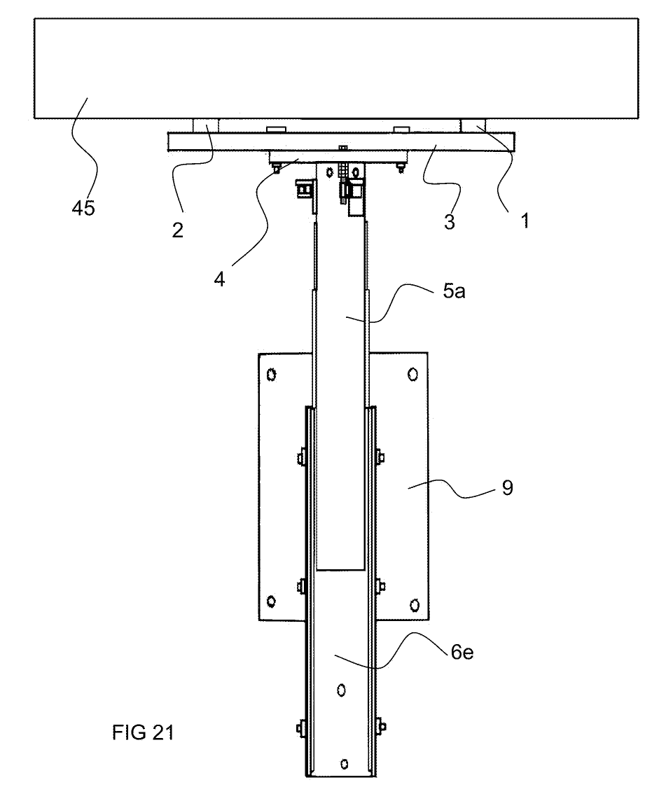

As shown in FIG. 21, the television, the VESA compliant television bracket, and the slide body assembly can now be connected to the upper mount assembly by connecting the removable outer extension drawer slides of the slide body assembly to the main body of the drawer slides of the upper mount assembly. FIGS. 19 and 20 also display the side views of how the television bracket and slide body assembly can be attached to the upper mount assembly via the drawer slides connecting together. The left and right removable outer extension slides 24 and 23 need to be lined up and fit together with corresponding left and right main slide bodies 40 and 39 and be locked in place. Once locked in, the installation of the television to the mount and to the furniture is complete.

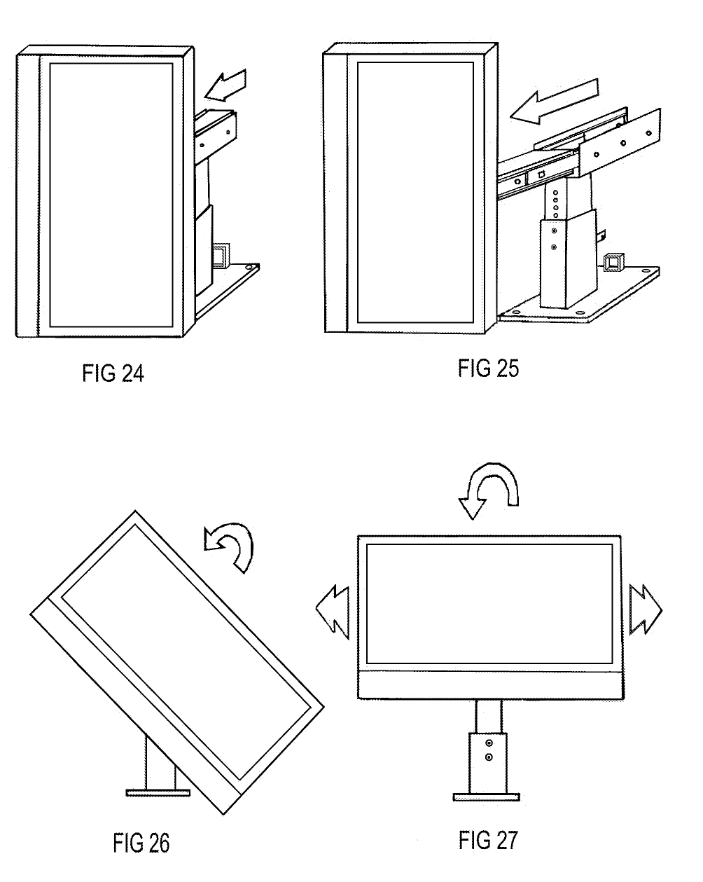

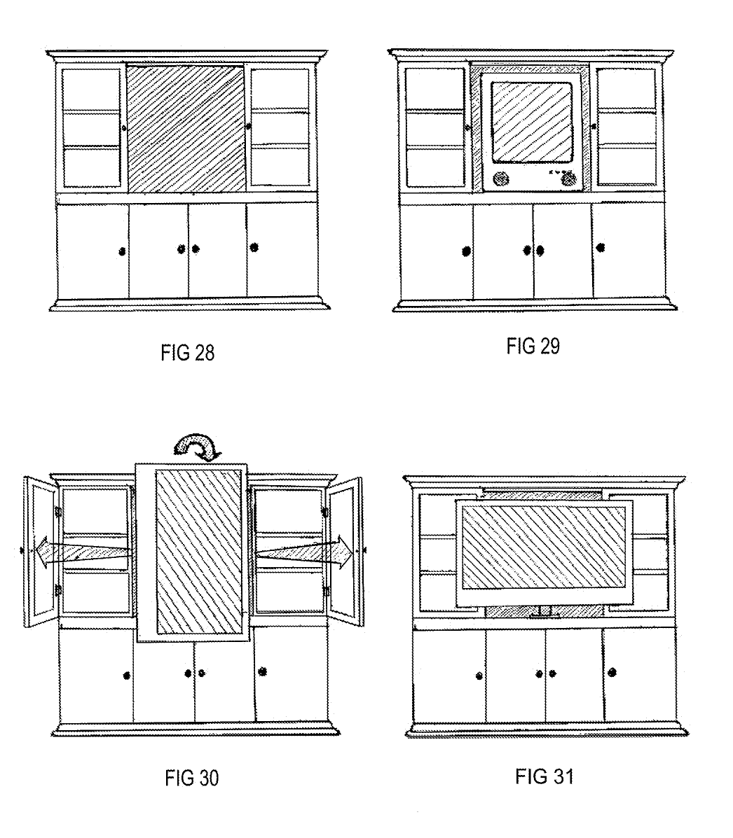

As shown in FIGS. 24 through 27, the television can go from a vertical, telescoped-in configuration of FIG. 24, to a vertical, telescoped-out configuration of FIG. 25, to a telescoped-out and rotating configuration of FIG. 26, and finally to a horizontal, telescoped-out configuration of FIG. 27. FIG. 28 shows an entertainment center furniture with a small square television compartment along with two hutches with doors on both sides. As shown in FIG. 29, only a small CRT television set can fit inside such furniture without the current invention. However, the current invention allows for the mounting of a large wide-screen display on to such furniture by allowing the television to be held outside the small opening. When there are side hutches with doors attached to such entertainment center as shown in FIG. 30, the television can be rotated to a vertical position to allow the hutch doors to be opened. In a similar fashion, when the television is in a horizontal viewing position as shown in FIG. 31, the bottom doors of the entertainment center can be opened as well. The rotational functionality of the mount makes it possible to open side hutches and bottom doors of the mounted furniture.

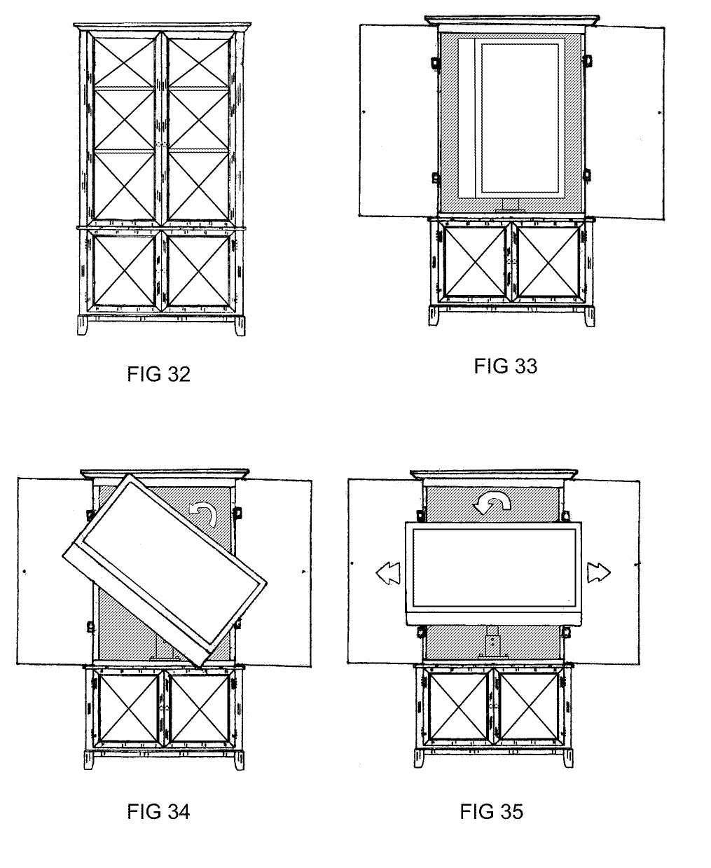

As shown in FIGS. 32 through 35, the wide-screen television can be mounted on an armoire entertainment center with doors that have a rectangular shape for the television compartment, wherein the width of the compartment is narrower than the length. Most older, large armoire entertainment centers were built in this aspect ratio due to the fact that the height of the furniture was very tall and it was built only to hold a CRT square tube television set with screen diameter no larger than 91.44 cm or thirty-six inches wide. FIG. 32 is a drawing of the furniture with the television compartment doors closed. FIG. 33 shows the television in a vertical, telescoped-in, storage configuration inside the armoire. The television can be telescoped-out and rotated as shown in FIG. 34, and then set to a horizontal, telescoped-out, viewing configuration as shown in FIG. 35. The telescoping and rotating function of the mount allows the television to be stored and put away from view when the television is not being used, while it can be telescoped out and rotated in a horizontal position for viewing.

In addition to the above two common uses for this television mount, this invention can also be used on a corner entertainment center unit with or without a television compartment (not shown in drawings). Without this invention, when a corner entertainment center unit is placed in a corner of the room, the adjoining two walls limits the size of television you can place on top of the corner unit. While you can pull the corner entertainment center out and away from it's natural fit in the corner of the room to accommodate a larger screen television set, this would look awkward aesthetically. However, by utilizing this new invention's telescoping feature, the corner entertainment center can stay in the corner, and just the television can be telescoped out far away from furniture, thus making it is possible to place a much larger display on the furniture.

This current invention can also be used as a replacement television stand in place of the manufacturer's supplied stand. The height adjustable function of the mount allows for increasing the height of the mounted television on top of a furniture, which can better the viewing angle of the mounted display. Also, by using this adjustable mount as a television stand, the television can be secured to the furniture, preventing the television from being moved or tipped over. In addition, the telescoping function of the mount makes it easier to access the rear cable connection panel for cable connections and adjustments.

Lastly, this new mount can be used in many different commercial settings. It can be used in a desktop configuration, where a large flat panel display can be mounted on a desk or any flat surface to be used as a computer monitor for high-resolution graphic work either in a horizontal or a vertical position. Also, the mount can install a flat panel display to be used as a sign or display/announcement board in a commercial setting by mounting on top of a counter or any square slot built into the wall. When used in such a setting, the mount's rotating function may become a hindrance, since a customer may bump and rotate the display accidentally and damage the display. The mount then can be set to a fixed horizontal or a fixed vertical position by simply adding an extra washer between the 12c and 13 in FIG. 5. This added restriction eliminates the gap between the rotational box insert and the VESA television bracket, thus eliminating the rotating feature of the mount. This simple addition will result in keeping the display in a fixed vertical or horizontal position for the mount be used in a commercial setting safely. The washer can also be removed later for the vertical or horizontal position to be changed when and if such a change is necessary in the future.

This new invention is invented for the purpose of mounting a large, wide-screen, flat panel television to any existing furniture of all sizes and shapes. The unique, multi-adjustable feature, along with the telescoping and the rotating functions of the mount, makes such mounting possible. This is the only mount that is durable and sturdy enough to hold a heavy television set in a fixed position, and at the same time, enables the mounted television to be rotated and telescoped in and out effortlessly. This mount can be used to mount any VESA compliant television larger than 58.42 cm or twenty-three inches in diameter onto any furniture with a solid horizontal baseboard.

The embodiments of the invention in which an exclusive property or privilege is claimed are defined as follows:

1. An adjustable television mount that telescopes and rotates a mounted flat panel display screen on a support comprising of five major components:
a VESA (Video Electronics Standards Association) compliant television bracket;
a rotational box insert;
a slide body assembly;
an upper mount assembly;
a base mount assembly;
wherein all five components are durably manufactured in metal to mount any VESA compliant wide-screen, flat panel television, with screen size in diameter larger than 58.42 cm or twenty-three inches, onto a horizontal baseboard of furniture or counter top for storage and viewing.

2. An adjustable television mount according to claim 1, wherein the mounted flat panel display screen can be telescoped in and out from the fixed position of the base mount assembly attached to the baseboard, and the mounted flat panel display screen can also be rotated or spun around in a single quadrant to be set in either a horizontal or a vertical position.

3. An adjustable television mount according to claim 1, wherein the adjustment means is configured for adjusting the orientation of the VESA compliant television bracket to fit and attach any VESA compliant television set larger than 58.42 cm or twenty-three inches in diameter and, for adjusting the distance traveled by telescoping of the slide body to and from the fixed base mount assembly; and lastly, for adjusting the height of the adjustable television mount to accommodate for different flat panel display screen sizes that can be mounted on the television mount.

4. An adjustable television mount according to claim 1, wherein the VESA compliant television bracket is consisting of three elongated metal plates assembled to form an H-shaped bracket and assembles as follows: two identical vertical plates with seven holes drilled along the middle can be adjusted alongside each half of the one horizontal plate in three different locations; thus the positioning of the two identical vertical strips along the one horizontal strip in identical distance from the center of the horizontal strip to each other results in a set of four holes on the ends of the vertical plates, which form the shape of a rectangle or a square, which is then used to attach any VESA compliant television set with screen size larger in diameter than 58.42 cm or twenty-three inches to the corresponding holes using four machine screws.

5. An adjustable television mount according to claim 1, wherein the VESA compliant television bracket is attached to an additional rectangular plate between the rear of the VESA compliant television bracket and the slide body assembly, and this television centering plate is adjustable vertically against the horizontal piece of the VESA compliant television bracket to center the mounted television and the bracket assembly in reference centrally to the actual point of rotation on the adjustable television mount; in addition, the television centering plate can be adjusted as to not cover up the rear cable connection panel of the attached television.

6. An adjustable television mount according to claim 1, wherein the VESA compliant television bracket and the television centering adjustment plate is attached to a rotational box insert, which enables the free-rotational movement of the television in a single plane perpendicular to the attached slide body assembly when connected to the adjustable television mount.

7. An adjustable television mount according to claim 6, wherein the rotational box insert of the adjustable television mount is comprised of a square metal tube, cut in a cubical shape, with a round hole drilled on the center of both opposite front and back sides to pass a bolt through the corresponding holes from the front to the rear; and thereby, attaching the VESA compliant television bracket to the rotational box insert using a set of hardware consisting of a partially threaded long bolt, a precision-cut spacer, a nut, a washer, and another nut (this last unit of washer and nut combination functions to hold the first nut in position securely).

8. An adjustable television mount according to claim 7, wherein the rotational box insert of the adjustable television mount has two additional corresponding holes each on the opposite top and bottom sides, with the holes being located closer to the front side of the mount; and each set of the two holes are used to attach the VESA compliant television bracket to the slide body assembly by the insertion of the rotational box insert into the front square opening of the slide body tube; wherein the four corresponding holes on top and bottom of the slide body tube overlap with the four holes of the rotational box insert, and two sets of nuts and bolts can be used to connect the parts together.

9. An adjustable television mount according to claim 7, wherein the rotational movement of the flat panel display screen mounted on the adjustable television mount is dampened by the precision cut metal spacer that goes on between the rotational box insert and the first nut on the long bolt, where the length of the spacer is precisely long enough to snugly fit between the rear side of the rotational box insert to the beginning line of the bolt's threading, a position where the nut stops moving when it's tightened to the maximum point on the bolt; and eventually, this miniscule gap that forms between the rotational box insert and the tightened nut, makes the rotational movement of the mounted display possible, while simultaneously preventing the undesirable tilting between the VESA compliant television bracket and the rotational box insert.

10. An adjustable television mount according to claim 9, wherein the adjustable television mount's rotating feature can be eliminated by inserting an additional washer around the bolt between the rear side of the rotational box insert and the spacer, thereby removing the gap between the VESA compliant television bracket and the rotational box insert which ultimately makes the rotating joint immobile; therefore, the television mount assembly can be used as a commercial display/announcement board, where it may be necessary for the display to be mounted on a fixed-horizontal or a fixed-vertical setting.

11. An adjustable television mount according to claim 1, wherein the slide body assembly is consisting of:
a square metal tube that has a square opening in the front of the embodiment while the rear may or may not have an opening;
a square metal tube which has plurality of holes along the two opposing vertical sides to accommodate attachments of a set of outermost removable pieces of a heavy-duty, full-extension drawer slides on each vertical two sides;
a square metal tube which has a set of two holes on each of the two opposing horizontal sides, top and bottom, in which the holes are located near the edges of the front of the slide body assembly to correspond to the location of the holes on the top and bottom sides of the rotational box insert, to accommodate two sets of nuts and bolts to attach the VESA compliant television bracket to the slide body assembly by the means of inserting the rotational box insert inside the front square opening of the slide body assembly, then lining up the holes; and finally, connecting the two components together by using the two sets of nuts and bolts.

12. An adjustable television mount according to claim 11, wherein the slide body assembly of the adjustable television mount has a rotation guidance system feature, which consists of two angle brackets welded on during the manufacturing of the mount accordingly: one on the top side and to the left edge of the slide body, and the other on the right side and to the bottom edge of the slide body, both placed away from the front plane of the slide body to allow enough room for the nuts and bolts attaching the VESA compliant television bracket and the television centering adjustment plate from hitting the rotation guidance system, as well as leaving enough room for the two sets of nuts and bolts that go on top of the slide body assembly when connecting it to the VESA compliant television bracket.

13. An adjustable television mount according to claim 12, wherein the rotation guidance system's angle brackets possess the dimensions as such: the width of the angle bracket measures an 0.32 cm or eighth inch shorter than half the width of the square length of the slide body tube to allow for exact centering of the rotated television in a set position; and a set of generic double roller catches, which are commonly used on cabinet doors to keep the doors closed, attached to the rear sides of each ends of the angle brackets; thus configuring the double roller catches to catch and hold in place the rotation stopping bolt and set the flat panel display screen on either a horizontal or a vertical resting state when the rotating movement has been stopped by the angle brackets.

14. An adjustable television mount according to claim 13, wherein a 5.08 cm or two inches long and a 0.64 cm or quarter inch thick bolt is fitted through two holes above the hole where the rotational box insert is attached to the VESA compliant television bracket, and is fastened by three or four identical nuts consecutively in the rear side of the television centering plate (the plurality of nuts prevents the bolt from bending by adding structural integrity to the bolt), whereby this bolt acts as the rotation stopping bolt by getting stopped by the corresponding inner edges of the rotation guidance system's angle brackets and by being held in place by the double roller catches that catch the bolt at the end of the rotation.

15. An adjustable television mount according to claim 1, wherein the upper mount assembly is consisting of:
an upper channel portion made of metal with plurality of holes along each vertical side to accommodate the attachment of a set of drawer slides' main body assembly within the inner sides of each channel;
an upper channel portion having two holes on the horizontal bottom side of the channel near the rear of the channel, for the purpose of attaching two aluminum support strips during installation to secure the mount to the baseboard and to the nearby wall;
a lower square tube portion made of metal which is welded on during the manufacturing process to the underside of the upper channel, off-centered and closer to the front of the mount to reduce the length of the lever arm, which reduces the amount of torque generated by the weight of the mounted television on the welded joint between the upper channel portion and the lower square tube portion of the upper mount assembly;
a lower square tube portion's front and back sides have plurality of corresponding, evenly drilled holes to accommodate the attachment and overall height adjustment of the upper mount assembly to the base mount assembly.

16. An adjustable television mount according to claim 1, wherein the VESA compliant television bracket and the slide body assembly attach to the upper mount assembly by sliding together into place, the drawer slides' outermost extension pieces attached on each side of the slide body assembly into the drawer slide's main body assembly attached inside each inner side of the channel portion of the upper mount assembly; thus creating a slide-out drawer system in which a television is set in place where the front panel of a drawer would normally be in a typical slide-out drawer system.

17. An adjustable television mount according to claim 1, wherein the base mount assembly is consisting of:
an upper square tube portion made of metal with an opening which is large enough to fit the upper mount assembly's square tube entirely inside the base mount assembly's square tube;
an upper square tube portion being shorter in length than the upper mount assembly's bottom square tube portion to have the upper mount assembly sit on top of the lower base mount plate when connected together to set this height as the starting point of height adjustment during installation;
an upper square tube portion with the opposing front and rear sides having two corresponding holes drilled on each side, with the two holes drilled apart from each other in length equal to two holes length apart on the upper mount assembly's square tube holes, to align them together for attaching the upper mount assembly to the base mount assembly with two sets of nuts and bolts inserted through the aligned holes during the height adjustment of the mount;
a lower rectangular plate portion made of metal that is welded together with the upper square tube portion on the center of the plate during the manufacturing of the mount, and has four holes on the corresponding outer four edges which are used to attach the mount to a horizontal baseboard of furniture, and lastly, a square metal piece with a square hole in the middle, welded on between the rear two holes on the top side of the base mount plate on a standing-up position.

18. An adjustable television mount according to claim 17, wherein a cable management system of the adjustable television mount consists of:
a channel shaped metal strip, with two holes near the outer edges of the strip and a third hole located in the middle of the strip, which gets attached to the rear lower hole of the base mount and upper mount assemblies' attachment point during the mount's height adjustment;
a thin, square metal tube which is welded on its one side in stand-up position along the top side of the base mount plate in the rear of the mount, behind the long square tube, and in between the rear two holes of the base mount plate.

19. An adjustable television mount according to claim 18, wherein the cable management system of the adjustable television mount keeps the cables from being tangled up and removes unsightly cables away from view by hiding them behind the square tube portion of the adjustable television mount by guiding the cables attached on the rear of the television through the channel shaped metal strip attached behind the square tube of the base mount assembly, which has a plastic cable tie connecting the two holed ends of the channel strip to form a square opening, and then by guiding the bundled cables through the square hole of the thin square metal tube welded on the base mount assembly's lower plate.

20. An adjustable television mount according to claim 1, wherein the adjustable television mount's safety features consist of three major components which are listed as follows:
a set of six metal angle brackets with holes in the middle of each adjoining sides that fit between the lower perpendicular jointed sides within a furniture between the inner side panel and the horizontal baseboard on all four corners and the middle of the each jointed sides, attaching to the furniture using wood screws on each hole to keep the baseboard joined to the side panels,
an 1.91 cm or three-quarter inch wide aluminum strip, with punched holes along the middle 1.27 cm or half inch apart and is 10.13 cm or four inches longer than the maximum adjustable height length between the lower side of the upper mount assembly's channel portion and the baseboard during the height adjustment of installation, which can be bent on each end to be fitted between the front hole of the rear portion of the bottom side of the channel portion of the upper mount assembly and a drilled hole of the baseboard located behind the base mount assembly's mounted position, using two sets of nuts and bolts on each end of the strip to secure the upper mount assembly to the baseboard;
an identical aluminum thin strip, which attaches under the channel portion on the second hole closer to the rear edge of the upper mount assembly by a set of nut and bolt, then the opposite end of this strip being attached to the wall using a sleeve-type hollow wall anchor (molly bolt) to secure the complete television mount assembly to the nearby wall and prevent the whole structure from tipping forward.
